(19) United States
(12) Patent Application Publication
(10) Pub. No.: US 2011/0264520 A1
(43) Pub. Date: Oct. 27, 2011

(54) FINDIT PRODUCT LOCATOR

(76) Inventor: John Christopher Puhakka, Helsinki (FI)

(21) Appl. No.: 12/964,944

(22) Filed: Dec. 10, 2010

Related U.S. Application Data
(60) Provisional application No. 61/285,417, filed on Dec. 10, 2009.

(51) Int. Cl. G06Q 30/00; G01C 21/00

(52) U.S. Cl. 705/14.49; 705/26.9; 701/201

(57) ABSTRACT

Findit is an invention in the field of navigation, search and communication methodologies with electronical devices. Invention makes possible to guide the user (with a smart phone or smilar mobile device equipped with navigation technology) from media (online, printed, radio and TV) directly to a location. Upon receiving a message with the item's location information, user can start navigation to it directly. In the message information can be displayed. During navigation, information can be fed to the user by broadcasting methods such as podcasts by using the navigation message and navigation program as delivery platform in real-time.

This application claims benefit of Provisional Application No. 61/285,417 filed on 10 Dec. 2009.

### TECHNICAL FIELD OF THE INVENTION

The invention relates to navigation, search and communication methodologies with electronical devices.

### BACKGROUND OF THE INVENTION

Finding products is too time-consuming and difficult. There are disadvantages in methods used today. Several different methods are needed to find and reach the product.
1. User finds the product online or sees an ad on newspaper or magazine.
2. User finds the location of store using different methods such as; searching online maps, printed maps or asks for directions. If he has a navigation equipped mobile device, he can enter the address and start navigation to the street address of the store.
3. Upon entering the store, he must “search, walk, wait and talk” to sales people to find the right aisle/shelf where the product is.

### SUMMARY OF THE INVENTION

“Findit” is a solution to these problems and makes finding items easy. “Findit” makes possible to guide the user (with a smart phone or smilar mobile device equipped with navigation technology) from media (online, printed, radio and TV) directly to the store and the product inside. Previously this has not been possible but several different methods were needed to find and reach the product. Upon receiving the Findit-message with the item's location information, user can start navigation directly. In the message audio-visual or textual information can be displayed, such as targeted advertising about the product. During navigation, the user is concentrated in messages from the navigation program, which makes it ideal time for displaying messages. Information can be fed to the user by broadcasting methods such as podcasts by using the navigation message and navigation program as delivery platform in real-time.

“Findit” also replaces countless hours of product location advising by sales people, which can be used e.g., to sell the product instead. The most common problem in shopping in large retail stores today is finding the product you want to buy. Usually a lot of walking and finding a sales person is required and then waiting to talk to him. “Findit” has strong effect on consumer choice. With “Findit”, customers don't need to search, walk, wait and talk to find the product they want to buy by making shopping experience easier. “Findit” creates a clear preference for the store with consumers who search and choose products online.

### BRIEF DESCRIPTION OF THE DRAWINGS

FIG. 1. Illustrates the function of the different components and methdologies of the system and information flow.

FIG. 2. Illustrates the function of different devices and methodologies in making use of the system and information in it.

### DETAILED DESCRIPTION

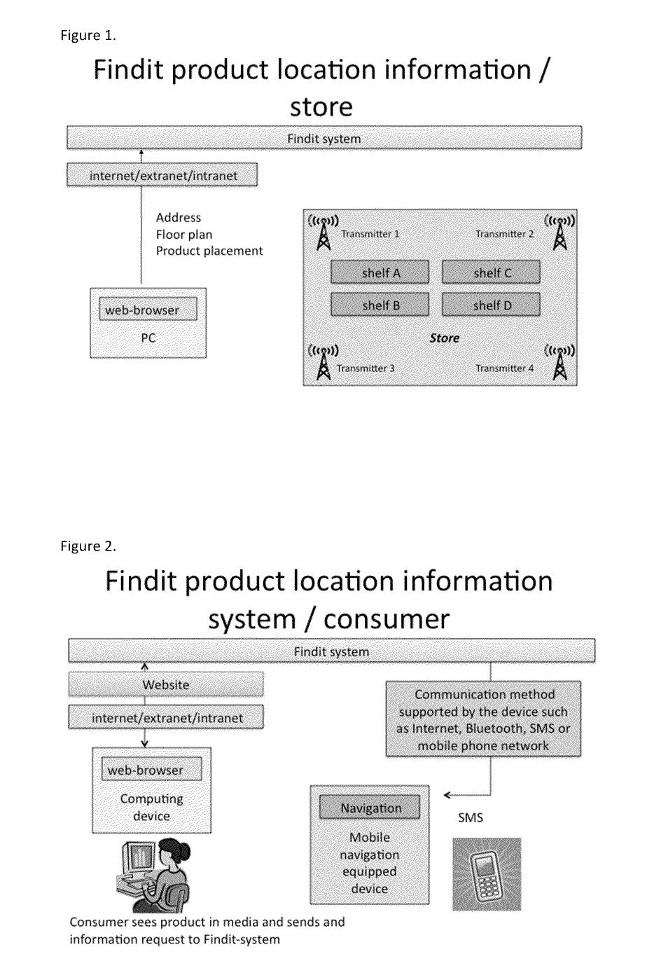

Creating “Findit” information system. We create the product coordinate location information and make it available to the user upon request by multi-channel distribution.
1. The street address of store is entered into GIS (Geographical Information System) database (FIG. 1)
2. Floor plan and product placement information are both entered in the GIS database (FIG. 1)
3. GIS established a coordinate system for the store that gives address, floorplan and each product a location in known coordinate space
4. “Findit”-information is linked into websites and printed media where products are displayed (FIG. 2)
5. Outdoor GPS signal is used for navigation to the store. Local positiong methdos are used indoors where GPS is not available. Transmitters such as Cellular base stations and WLAN, RFID and Pseudolites etc. with identifiable signals are placed in known positions in the store to create local triangulation navigation space for mobile computing and other devices such as smart phones, tablet computers etc. (FIGS. 1 and 2.).

Using “Findit”information system.
1. User finds the product online or on printed media; A “Findit” information availability indicator such as a logo is displayed next to each product online or offline (printed media, radio and tv commercials) providing the location of the store and the product (FIG. 2.).
2. User sends an information request to “Findit” system. (a) online he can click “Findit”-logo next to the product, (b) offline (printed media) he takes a photo of the UpCode or similar optical information field and sends a service request to “Findit” system, (c) on radio and TV ads he can send an SMS request to a “Findit”-number etc. (FIG. 2).
3. Next, the location of the store and where the product is in the store is sent from “Findit” system database to the user; by using Internet connection or by SMS, bluetooth or other communication method supported by user's device (FIG. 2).
4. After receiving the information, user is guided to the store and the product itself using navigation program in the device and available signals for navigation outdoors and indoors (FIG. 2.). Upon receiving the message, further information can be displayes e.g., about the route to the store (traffic), product information, advertising, electronic coupons etc.

### A GENERAL STATEMENT OF THE INVENTION

I have invented a way to guide consumers from media to products in stores (online shops, search engines, printed ads, radio and TV). Before this has not been possible but several different methods and step were needed to find desired store and item. By making this possible, I have also invented a way to create a strong effect on consumer choice. The invention also makes possible to deliver general or targeted information in a new way to the user about the product/location/store/traffic etc. Last but not least, I have invented a way to save a lot of time in product placement advising; sales people save a lot of time when customers can find the products themselves without asking for help.

1. “Findit” is computer information system that is arranged to perform a function to guide the user from media to its location in real world. “Findit” records the floor plan and item placement in a space such as a storeroom and creates a known location in coordinate system for the space and items in it. The information in the system is made available to users in media such as online search engines, websites, printed media like newspapers and magazines, billboards and broadcast media TV and radio. Information can be transmitted to devices such as computers and mobile electronic devices via different methods supported by such devices such as the Internet, SMS or email messages, bluetooth etc. Upon receiving the information from “Findit” system, a device with navigation functionality can guide the user to the location of the item.

2. A method according to claim 1, wherein GPS signals are used to compute the location of the device in relation to the item (product) and guide the user in to it. Where GPS signal is not available (such as indoors), local positioning methods are employed using available signals such as Cellular base stations, Wi-Fi, WLAN, RFID, and Pseudolites etc. are used for triangulatation and calculatation of the position of the user's device in relation to the item in the space.

3. A method according to claim 1, wherein the system replaces time spent on product location advising by human resources (sales people etc.).

4. A method according to claim 1, wherein making navigation to the item possible creates consumer preference (store/manufacturer etc.).

5. A method according to claim 1, where in new way to deliver ads and messages is created. Consumer can be delivered targeted messages during navigation. Information can be fed to the user in real-time by broadcasting methods such as podcasts by using the navigation message, navigation program and electronic devices's capabilies as delivery platform.
